(19) United States
(12) Patent Application Publication
(10) Pub. No.: US 2026/0340750 A1
(43) Pub. Date: Oct. 29, 2026

(54) WARDIAN SUITE: System and Method for Integrated Digital Child and Adult Welfare Intelligent Case Management with Smart Intake, Smart Risk Assessment, Inter-Agency Collaboration, and Predictive Analytics.

(71) Applicant: New Vision Institute of Technology Inc, Frisco, TX (US)

(72) Inventor: Elisha Tweneboah Kodua, GEORGETOWN, TX (US)

(73) Assignee: New Vision Institute of Technology Inc, Frisco, TX (US)

(21) Appl. No.: 19/236,266

(22) Filed: Jun. 12, 2025

Related U.S. Application Data
(60) Provisional application No. 63/793,849, filed on Apr. 24, 2025.

(51) Int. Cl. G06Q 50/22; G06F 21/60; G06F 40/58

(52) U.S. Cl. CPC G06Q 50/22; G06F 21/602; G06F 40/58

(57) ABSTRACT

A system and method for integrated child and adult welfare case management. The invention, Wardian Suite, provides a modular digital platform with smart intake clarity tools, predictive risk assessment, inter-agency data exchange, visual workload dashboards, secure mobile field tools, and audit-compliant reporting. The platform enables real-time collaboration among investigators, supervisors, and agencies, while ensuring policy compliance and tamper-evident documentation. The system improves clarity, accountability, and safety outcomes through automation, predictive analytics, and quantum-secure data handling.

### FIELD OF THE INVENTION

The present invention relates to systems and methods for digital child and adult welfare case management. More specifically, it concerns a modular, intelligent, and policy-aligned platform known as WARDIAN SUITE, integrating tools for intake, background screening, case tracking, service implementation, and predictive analytics for child and adult protective services.

### BACKGROUND OF THE INVENTION

Conventional welfare systems suffer from fragmented data entry, unclear narratives, manual service tracking, policy noncompliance, and weak supervisory oversight. Existing platforms often lack intelligent integration, field operability, and scalability. A unified, policy-driven solution is needed that supports intake workers, investigators, supervisors, and administrators across the entire case lifecycle.

### SUMMARY OF THE INVENTION

The present invention provides an all-in-one digital platform—WARDIAN SUITE—that includes:
Smart Intake Clarity Tools (SICT)
Background intelligence integration (PBIC)
Predictive analytics and risk scoring (SAM modules)
Visual workload dashboards and Kanban task systems
Enterprise document and content management (EDCM)
Inter-agency data interoperability (FHIR, NIEM compliant)
Secure mobile tools with offline field sync
Court-ready documentation and digital signatures
In-built training simulator and certification tracker
Role-based intelligence dashboards (RBID)
Full audit logging, security, and policy compliance modules
Modular workflow builder and case rule designer
Automated federal compliance report generation
Emergency and safety alerts with live GPS tracking

### DETAILED DESCRIPTION OF THE INVENTION

### I. Core Casework Intelligence & Intake Modules

### 1. Smart Intake Clarity Tool (SICT)

Expands abbreviations into full DFPS terms
Auto-suggests phrases based on selected roles
Clean toggle for supervisor review

### 2. Smart Intake Sorting Tab

Automatically routes cases into AR or TI
Includes manual override alerts for supervisor decisions

### 3. Integrated Person Background Intelligence Check (PBIC)

Pulls from FBI NCIC, state law enforcement, DFPS, HHSC, and USCIS databases
Flags records in real-time with role-controlled access and audit logging

### 4. Geographic Risk Mapping & Local Service Overlay

Risk-score addresses
Highlights known high-risk areas and maps local resources (e.g., shelters, clinics)

### 5. Interview Documentation Module

Captures audio, performs speech-to-text, applies sentiment tagging
Outputs court-formatted narratives with editable summaries

### 6. Collaborative Safety Plan Canvas

Drag-and-drop service planning
Joint e-signature, editable goals, real-time update capability

### 7. Court Report Generator

Automatically prepares hearing-specific documents using recorded case actions

### II. Predictive Analytics, Assessment & Decision Support

### 8. Risk Assessment & Predictive Readiness Suite (SAM)

Includes SSA, SPFB, RRE, EOT modules
Manually completed, AI-ready backend

### 9. Smart Assessment Modules (SAM)

Policy-based, AI-ready modules for case scoring, tagged JSON structure

### 10. Decision Intelligence Layer

Predictive modeling for safety, service gaps, and placement risks

### 11. Early Exit Readiness Score

Quantifies readiness for early closure using risk and participation indicators

### III. Tracking, Handoff, and Workflow Tools

### 12. Courtesy & Transfer Tracker+SafeHandoff™

Tracks cross-region and intra-agency transfers
Digital handoff receipts, deadline alerts, chain-of-custody logs

### 13. Warm Handoff Tracker

Follows up on referrals post-case closure with provider confirmations

### 14. Structured Case Disposition Generator

Auto-compiles final case reports to DFPS closure standards

### 15. Service Implementation & Referral Tracker (SIRT)

Tracks referrals, completions, timelines, and alerts

### 16. Visual Workflow & Case Rule Designer

Low-code automation builder for alerts, escalations, testing rules

### 17. Time-to-Task Logger+Burnout Detector

Tracks task durations and workload trends
Triggers supervisor alerts for excessive load or overdue performance

### IV. Supervision, Dashboards & Internal Communication

### 18. Role-Based Intelligence Dashboards (RBID)

Dashboards tailored for:
   Caseworkers
   Supervisors
   Regional directors
   State executives
   New hires in training mode

### 19. Real-Time Investigator Map

Supervisors can view field activity live

### 20. Secure In-app Messaging

Role-based communication tied to specific cases with full audit logging

### 21. Inter-Case Intelligence Linking

Detects duplicates, flags cross-regional records with smart identifiers

### V. Field Tools, Mobility & Notetaking

### 22. Mobile & Field Tools+Emergency Escalation

GPS trip logging, panic button, voice transcription, photo uploads
Works in offline mode; syncs upon re-connection

### 23. Digital Notebook & Call Logger

Stylus support, transcription, timestamped summaries, searchable notes

### 24. Wardian Suite Miles

Mileage and route tracking
Fuel expense logging, geo-fencing, time-on-site analytics

### 25. Offline Mode & Sync Engine

Encrypted offline mobile capture with auto sync and conflict handling

### VI. Training & Simulation

26. Training & Mentorship Simulator (ptme)
Staged onboarding with mock cases, mentor dashboards, auto-feedback, graded case tasks

### 27. AR Training Simulator & Dashboard

Scores workers on engagement, empathy, and compliance with AR strategy

### VII. APS-Specific Modules

### 28. APS Risk Assessment Engine

Focused on elder/self-neglect, caregiver abuse, and environmental safety
Includes scoring cards and trend monitoring

### 29. Aps Incident Type Library

Includes: financial exploitation, institutional neglect, self-endangerment
30. joint APS-CPS dashboard
Enables multi-program view of linked cases and shared safety plans

### 31. Legal Tracker & Capacity Notifier

Manages legal orders, available beds, shelters, and time-sensitive filings

### 32. Special Needs Registry & POA Verifier

Integrates with disability databases and court guardianship systems

### VIII. AR Optimization Suite

### 33. AR Suitability Screener

Filters cases at intake using policy-based eligibility

### 34. Ar Engagement Wizard

Trauma-informed guided conversation tool

### 35. Voluntary Service Agreement Generator

E-signable document builder in plain-language format with translation support

### IX. Security, Compliance & Infrastructure

### 36. Security & Compliance Engine

AES-256 encryption, role-based access, HIPAA/CJIS/DFPS compliance

### 37. Security, Audit & Retention Framework

Immutable logs, deletion locks, family code compliance

### 38. Compliance & Reporting Engine

AFCARS, CFSR, NYTD report exports with validation and dashboards

### 39. Enterprise Document & Content Management (EDCM)

Secure storage, OCR search, metadata tagging, legal holds, role-based access

### 40. Standardized Interoperability Hub

FHIR/NIEM APIs for court, Medicaid, schools
Visual interface builder, sandbox integration testing

### 41. Multilingual Translation Support

Real-time voice and text translation
Document and message translation
Offline language packs
Language memory per client

### 42. Enhanced Case Management Core

Event strips, outcome anchors, family tree, contract directory

### 43. Task Kanban & Visualization

Drag-and-drop board, AI-based reordering, heatmaps

### Conclusion

WARDIAN SUITE unifies intake, investigation, service implementation, supervision, and analytics into a scalable, secure, and policy-aligned platform for modern child and adult protection services. Through modular intelligence, field readiness, compliance automation, and predictive insights, it enables a more responsive, accountable, and human-centered digital transformation of casework.

### Claims

To follow based on final specification and figures.

### DRAWINGS

FIG. 1: System Architecture Diagram

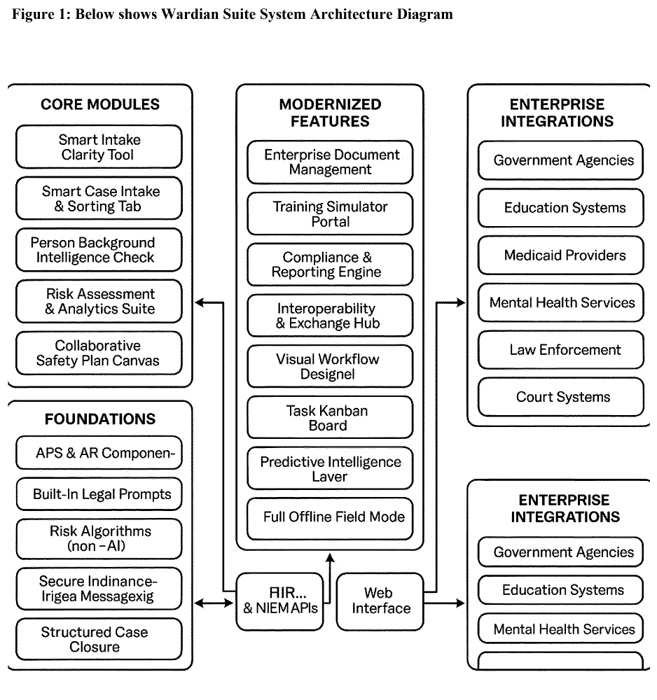

FIG. 2: Mobile and Web UI Flowcharts

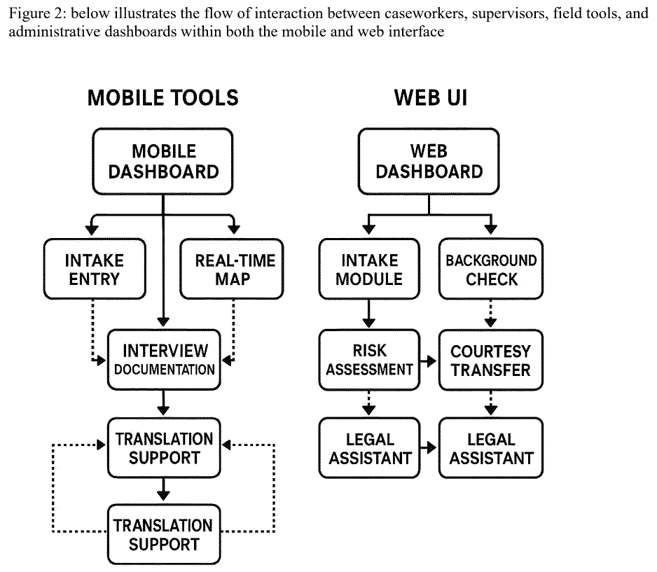

FIG. 3: Module Workflows-SICT, PBIC, SAM, PTME, RBID, SafeHandoff

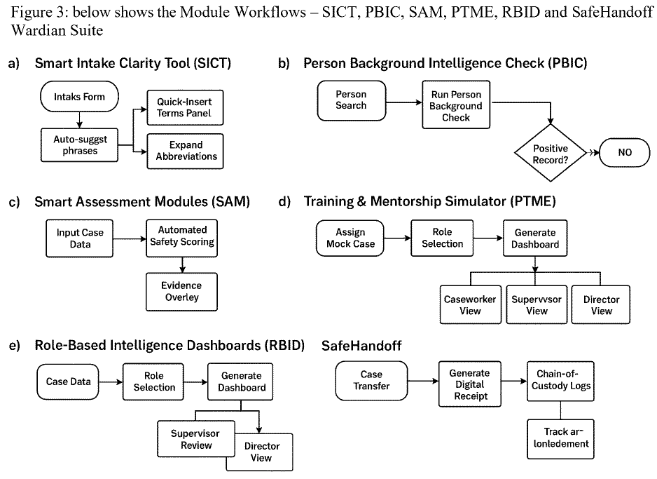

FIG. 4: Timeline & Integration Schematic

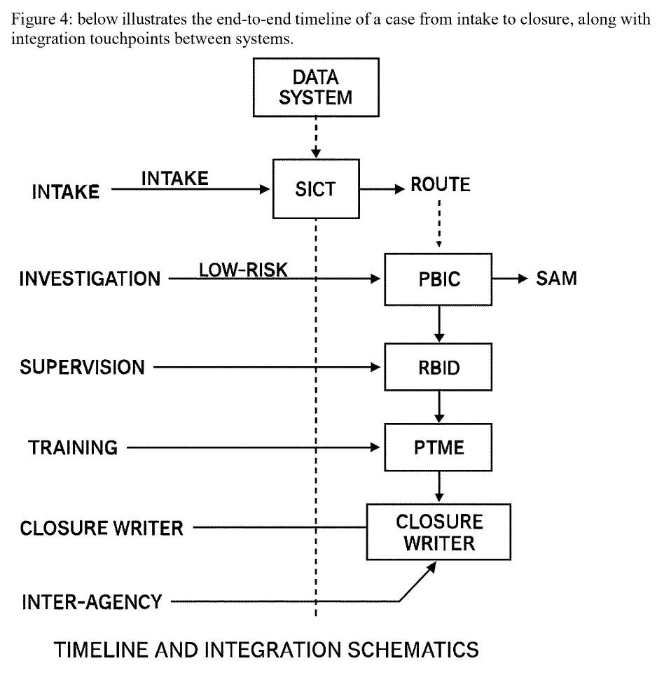

8. A smart intake clarity system for use in child protective investigations, comprising:
a phrase expansion module configured to convert ambiguous shorthand or caseworker-entered phrases into standardized Department of Family and Protective Services (DFPS) intake terminology;
a multilingual translation module configured to render caregiver or witness statements into DFPS-accepted English terminology while retaining context of abuse, neglect, or dependency allegations;
an intake alignment engine configured to automatically map expanded phrases and translated statements to statutory DFPS intake categories, including at least neglectful supervision, physical abuse, emotional abuse, or medical neglect; and
a post-quantum audit integration configured to encrypt each intake record at the point of entry and append a TouchTrace DNA audit log documenting the intake source, translation, and expansion decision.

9. The system of claim 8, wherein the phrase expansion module uses a DFPS-approved glossary maintained in a centralized knowledge base.

10. The system of claim 8, wherein translations are stored with dual-language tagging to preserve both source and standardized versions.

11. The system of claim 8, further comprising automated flagging of high-risk phrases for supervisor review prior to case acceptance.

17. A system for securing child and adult protective services case records, comprising:
a post-quantum cryptographic module configured to encrypt files and live editing sessions at the moment of creation using a Kyber key exchange and Dilithium digital signatures;
a TouchTrace DNA audit engine configured to generate immutable, tamper-evident logs of each user interaction, the log including at least one of: a device identifier, user identifier, internet protocol address, geolocation, and timestamp;
a ContextGuard module configured to automatically trigger encryption lockouts when detecting at least one of: a virtual private network spoof, abnormal geolocation, or an IT system blackout; and
a policy enforcement engine configured to classify case documents by sensitivity level and apply corresponding access rules, wherein the rules include at least one of: automatic watermarking, dual-signature approval, or auto-encrypt retention.

18. The system of claim 17, wherein the TouchTrace DNA audit logs are cryptographically anchored to a blockchain ledger for tamper-evidence.

19. The system of claim 17, wherein the ContextGuard locks include disabling offline access until a security review is completed.

20. A mobile field investigation system for protective services, comprising:
an offline-capable mobile application configured to capture caseworker notes, voice dictation, images, and geolocation data in the field without continuous network connectivity;
a synchronization engine configured to automatically encrypt and upload field-collected data upon reconnection using post-quantum secure session keys;
a liveness-detection module configured to verify the identity of the field caseworker prior to granting access to protected records on the device; and
a TouchTrace DNA log integration configured to record, in immutable audit form, each field entry, synchronization event, and identity check.

21. The system of claim 20, wherein the mobile application enforces biometric verification using facial or voice recognition before offline use.

22. The system of claim 20, wherein synchronization includes delta-based updates to minimize data exposure.

23. The system of claim 20, wherein offline cached data is automatically destroyed after a configurable retention period.
